(19) United States
(12) Patent Application Publication
(10) Pub. No.: US 2019/0130331 A1
(43) Pub. Date: May 2, 2019

(54) CARRYING SYSTEM, MANAGEMENT SERVER, AND METHOD FOR CARRYING USER

(71) Applicant: TOYOTA JIDOSHA KABUSHIKI KAISHA, Toyota-shi (JP)

(72) Inventors: Naomi KATAOKA, Nagoya-shi (JP); Toshiaki NIWA, Okazaki-shi (JP); Yasuhiro BABA, Kamo-gun (JP); Katsuhiko YOUROU, Toyonaka-shi (JP); Kazuyuki KAGAWA, Nisshin-shi (JP)

(73) Assignee: TOYOTA JIDOSHA KABUSHIKI KAISHA, Toyota-shi (JP)

(21) Appl. No.: 16/175,937

(22) Filed: Oct. 31, 2018

(30) Foreign Application Priority Data
Nov. 2, 2017 (JP) 2017-212778

(51) Int. Cl. G06Q 10/06; H04L 29/08

(52) U.S. Cl. CPC G06Q 10/06314; H04N 7/181; H04L 67/18; H04L 67/10

(57) ABSTRACT

A management server is configured to receive a flight schedule and a boarding procedure progress status of a user from an airport server configured to manage a boarding procedure of the user, and is configured to specify a location of a delayed user in the airport, the delayed user being a user who is delayed for the boarding procedure. The management server is configured to dispatch a vehicle to the delayed user and transmit, to the vehicle, an instruction for carrying the delayed user to a location of a procedure which the delayed user has not been through in the boarding procedure. The vehicle is configured to: move to the delayed user in accordance with the instruction; and move, in accordance with the instruction, to the location of the procedure which the delayed user has not been through, after the delayed user rides on the vehicle.

This nonprovisional application is based on Japanese Patent Application No. 2017-212778 filed on Nov. 2, 2017, with the Japan Patent Office, the entire contents of which are hereby incorporated by reference.

### BACKGROUND

### Field

The present disclosure relates to a carrying system, a management server, and a method for carrying a user. In particular, the present disclosure relates to: a carrying system for carrying a user to a location of a procedure required for boarding in an airport, using a movable body configured to perform unmanned driving; a management server used for the carrying system; and a method for carrying a user in the airport.

### Description of the Background Art

Japanese Patent Laying-Open No. 6-242823 discloses an automatic conveying vehicle utilizable in an airport. A portable baggage of a user, who uses the airport, can be loaded on this automatic conveying vehicle. The automatic conveying vehicle can move in the airport in accordance with a desired traveling route selected by the user. The automatic conveying vehicle includes means for moving while keeping a constant distance from the user, and the user may just follow the automatic conveying vehicle (see Japanese Patent Laying-Open No. 6-242823).

The automatic conveying vehicle described in the patent publication moves inside the airport in accordance with the need of the user who utilizes the airport. On the other hand, in the airport, there is the airport company's need of immediately transporting a user, who has not been through a procedure required for boarding although the boarding time is coming, to a location of the procedure. The automatic conveying vehicle described in the above-described patent publication cannot cope with the airport company's need.

### SUMMARY

The present disclosure has been made to solve such a problem and has an object to provide: a carrying system for immediately transporting a user, who is delayed for a boarding procedure in an airport, to a location of the procedure using a movable body configured to perform unmanned driving; a management server used for the carrying system; and a method for carrying the user.

A carrying system according to the present disclosure is a carrying system for carrying a user to a location of a procedure required for boarding in an airport, and the carrying system includes a movable body and a management server configured to manage movement of the movable body. The movable body is configured to perform unmanned driving and used for transportation of the user in the airport. The management server is configured to receive a flight schedule and a boarding procedure progress status of the user from an airport server configured to manage a boarding procedure of the user, and is configured to specify a location of a delayed user in the airport, the delayed user being the user who is delayed for the boarding procedure. The management server is configured to dispatch the movable body to the delayed user and transmit, to the movable body, an instruction for carrying the delayed user to a location of a procedure which the delayed user has not been through in the boarding procedure. The movable body is configured to: move to the delayed user in accordance with the instruction; and move, in accordance with the instruction, to the location of the procedure which the delayed user has not been through, after the delayed user rides on the movable body.

According to the above-mentioned configuration, in the airport, the movable body can be dispatched to the user who is delayed for the boarding procedure, whereby the user can be immediately transported to the location of the procedure which the delayed user has not been through in the boarding procedure. As a result, flight can be suppressed from being delayed due to the delay of the user for the boarding procedure.

The management server may be configured to: obtain images of a plurality of cameras installed in the airport; and specify a location of the delayed user in the airport using the obtained images.

Accordingly, even when there is no location information from the user's mobile terminal or the like, the location of the delayed user in the airport can be specified immediately and the movable body can be dispatched to the delayed user.

The management server may be configured to: obtain location information of the delayed user from a mobile terminal of the delayed user; and modify a dispatch location for the movable body in accordance with the obtained location information.

Accordingly, the movable body can be correctly dispatched to the delayed user.

Further, a management server according to the present disclosure includes: a communication device configured to communicate with a movable body, the movable body being configured to perform unmanned driving and used for transportation of a user in an airport; and a processor configured to perform first to third processes. The first process is a process for receiving a flight schedule and a boarding procedure progress status of the user from an airport server configured to manage a boarding procedure of the user. The second process is a process for specifying a location of a delayed user in the airport, the delayed user being the user who is delayed for the boarding procedure. The third process is a process for dispatching the movable body to the delayed user and transmitting, to the movable body, an instruction for carrying the delayed user to a location of a procedure which the delayed user has not been through in the boarding procedure.

Further, a carrying method according to the present disclosure is a method for carrying a user in an airport using a movable body configured to perform unmanned driving, and the method includes: obtaining a flight schedule and a boarding procedure progress status of the user from an airport server configured to manage a boarding procedure of the user; specifying a location of a delayed user in the airport, the delayed user being a user who is delayed for the boarding procedure; dispatching the movable body to the delayed user and notifying, to the movable body, an instruction for carrying the delayed user to a location of a procedure which the delayed user has not been through in the boarding procedure; moving the movable body to the delayed user in accordance with the instruction; and moving, in accordance with the instruction, the movable body to the location of the procedure which the delayed user has not been through, after the delayed user rides on the movable body.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows an entire configuration of a carrying system.

FIG. 2 shows an exemplary configuration of a vehicle.

FIG. 3 shows configurations of a controller of the vehicle and a management server more in detail.

FIG. 4 is a sequence diagram showing exchange of information among respective elements of the carrying system according to the present embodiment.

FIG. 5 shows a configuration of data stored in a user information DB of the management server.

FIG. 6 is a flowchart for illustrating a procedure of processes performed by a processor of the management server.

FIG. 7 is a sequence diagram showing exchange of information among respective elements of a carrying system according to a modification.

FIG. 8 is a flowchart for illustrating a procedure of processes performed by a processor of the management server in the modification.

### DESCRIPTION OF THE PREFERRED EMBODIMENTS

The following describes embodiments of the present disclosure with reference to figures in detail. It should be noted that the same or corresponding portions are given the same reference characters and are not described repeatedly.

<System Configuration>

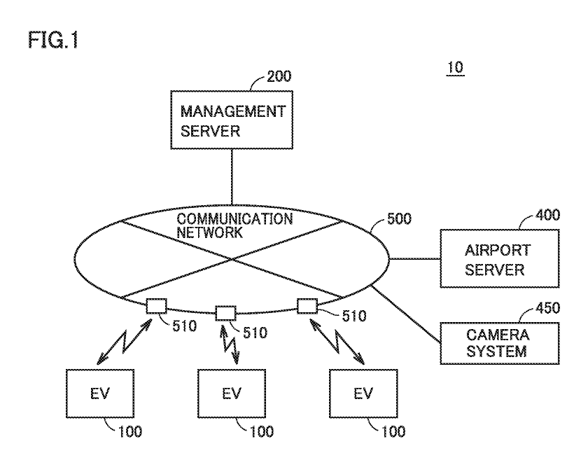

FIG. 1 schematically shows an entire configuration of a carrying system 10 according to the present embodiment. With reference to FIG. 1, carrying system 10 includes a plurality of vehicles 100, a management server 200, an airport server 400, and a camera system 450. Each vehicle 100, management server 200, airport server 400, and camera system 450 are configured to communicate with one another via a communication network 500. It should be noted that each vehicle 100 is configured to send and receive information to and from a base station 510 of communication network 500 through wireless communication.

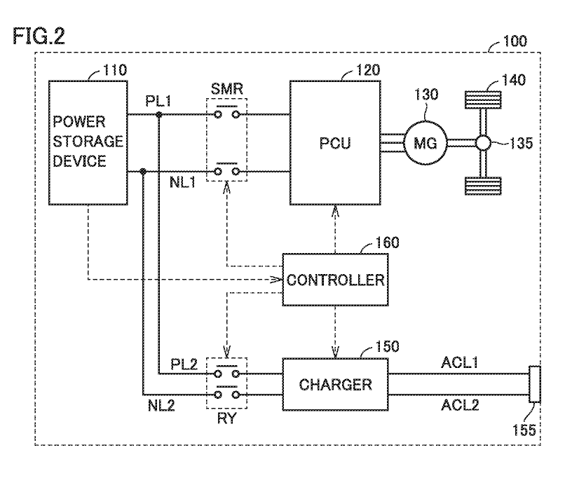

Vehicle 100 is a movable body configured to perform unmanned driving, and is used for transportation of a user in an airport. Vehicle 100 is a small electric vehicle (EV). As described below with reference to FIG. 2, vehicle 100 is configured to travel using electric power from a power storage device mounted thereon and to permit charging of the power storage device using electric power supplied from a power supply external to the vehicle.

Management server 200 is configured to communicate with each vehicle 100, airport server 400 and camera system 450 via communication network 500 to exchange various types of information among each vehicle 100, airport server 400 and camera system 450. Operations of management server 200 will be described in detail later.

Airport server 400 is configured to manage: flight schedules of aircrafts that depart from and arrive at the airport; and a boarding procedures for each user who is scheduled for a flight from the airport. Specifically, the boarding procedure includes various procedures such as check-in, safety inspection, emigration examination (in the case of international flights), and a boarding gate check. For these various procedures, airport server 400 manages a procedure progress status of each user who is scheduled for a flight.

Camera system 450 is configured to include a plurality of cameras installed in respective locations of the airport, and can capture an image of each user who moves in the airport. Each camera has an image-capturing precision to such an extent that the face of the user who moves in the airport can be discerned.

FIG. 2 shows a exemplary configuration of vehicle 100 shown in FIG. 1. With reference to FIG. 2, vehicle 100 includes power storage device 110, a system main relay SMR, a PCU (Power Control Unit) 120, a motor generator 130, a power transmission gear 135, and driving wheels 140. Moreover, vehicle 100 further includes a charger 150, an inlet 155, a charging relay RY, and a controller 160.

Power storage device 110 is a power storage component configured to be chargeable/dischargeable. Power storage device 110 is configured to include a secondary battery such as a lithium ion battery or a nickel-hydrogen battery, or include a power storage element such as an electric double layer capacitor, for example. Via system main relay SMR, power storage device 110 supplies PCU 120 with electric power for generating driving power of vehicle 100. Further, power storage device 110 stores electric power generated by motor generator 130.

PCU 120 is a driving device for driving motor generator 130, and is configured to include a power converting device such as a converter, an inverter, or the like (all not shown). PCU 120 is controlled by a control signal from controller 160 and converts DC power received from power storage device 110 into AC power for driving motor generator 130.

Motor generator 130 is an AC rotating electrical machine, such as a permanent-magnet type synchronous motor including a rotor having a permanent magnet embedded therein. Output torque of motor generator 130 is transmitted to driving wheels 140 via power transmitting gear 135 to travel vehicle 100. Moreover, motor generator 130 is capable of generating electric power using rotation power of driving wheels 140 when vehicle 100 operates for braking. The electric power thus generated is converted by PCU 120 into charging power for power storage device 110.

Charger 150 is connected to power storage device 110 through charging relay RY. Moreover, charger 150 is connected to inlet 155 by power lines ACL 1, ACL 2. Charger 150 converts electric power supplied from the power supply, which is external to the vehicle and electrically connected to inlet 155, into electric power with which power storage device 110 can be charged.

Controller 160 includes an ECU (Electronic Control Unit), various sensors, and a navigation device, a communication module, and the like (not shown in FIG. 2), receives signals from a sensor group, outputs a control signal to each device, and controls vehicle 100 and each device. Controller 160 performs various types of control for performing unmanned driving of vehicle 100 (such as driving control, braking control, and steering control). Controller 160 generates control signals for controlling PCU 120, a steering device not shown in the figure, charger 150, and the like.

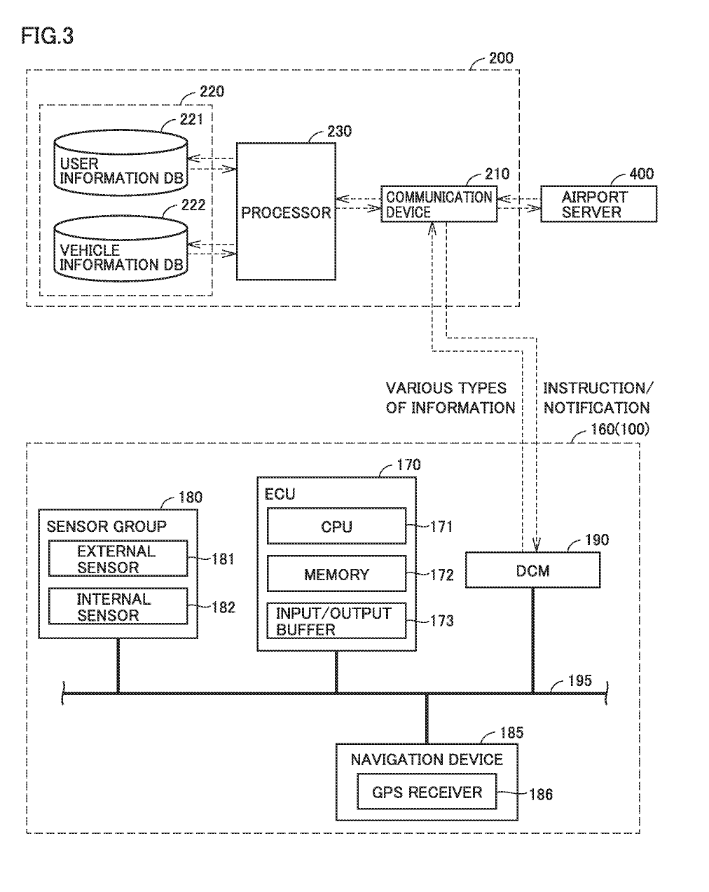

FIG. 3 shows configurations of controller 160 of vehicle 100 and management server 200 more in detail. With reference to FIG. 3, controller 160 of vehicle 100 includes an ECU 170, a sensor group 180, a navigation device 185, and a communication module 190. ECU 170, sensor group 180, navigation device 185, and communication module 190 are connected to one another via an in-vehicle wired network 195 such as a CAN (Controller Area Network).

ECU 170 is configured to include a CPU (Central Processing Unit) 171, a memory 172, and an input/output buffer 173. In response to a signal from each sensor of sensor group 180, ECU 170 controls devices to bring vehicle 100 into a desired state. For example, ECU 170 performs various types of control for implementing the unmanned driving of vehicle 100 by controlling PCU 120 (FIG. 2) serving as a driving device and the steering device (not shown).

It should be noted that the term “unmanned driving” refers to driving in which driving operations of vehicle 100 such as acceleration, deceleration, and steering are performed without driving operations by a driver. Therefore, controller 160 includes sensor group 180 to detect situations inside and outside vehicle 100. Sensor group 180 includes: an external sensor 181 configured to detect a situation outside vehicle 100; and an internal sensor 182 configured to detect information corresponding to a traveling state of vehicle 100 and detect a steering operation, an accelerating operation, and a braking operation.

External sensor 181 includes a camera, a radar, a LIDAR (Laser Imaging Detection And Ranging), and the like, for example (all not shown). The camera captures an image of a situation outside vehicle 100 and outputs, to ECU 170, captured-image information regarding the situation outside vehicle 100. The radar transmits electric wave (for example, millimeter wave) to surroundings of vehicle 100 and receives electric wave reflected by an obstacle to detect the obstacle. Then, the radar outputs, to ECU 170, a distance to the obstacle and a direction of the obstacle as obstacle information regarding the obstacle. The LIDAR transmits light (typically, ultraviolet rays, visible rays, or near infrared rays) to surroundings of vehicle 100 and receives light reflected by an obstacle to measure a distance to the reflecting point and detect the obstacle. The LIDAR outputs, to ECU 170, the distance to the obstacle and a direction of the obstacle as obstacle information, for example.

Internal sensor 182 includes a vehicle speed sensor, an acceleration sensor, a yaw rate sensor, and the like, for example (all not shown). The vehicle speed sensor is provided at a wheel of vehicle 100 or a drive shaft that is rotated together with the wheel, detects a rotating speed of the wheel, and outputs vehicle speed information including the speed of vehicle 100 to ECU 170. The acceleration sensor includes: a forward/backward acceleration sensor configured to detect acceleration in a forward/backward direction of vehicle 100; and a lateral acceleration sensor configured to detect lateral acceleration of vehicle 100, for example. The acceleration sensor outputs acceleration information including both the accelerations to ECU 170. The yaw rate sensor detects a yaw rate (rotation angle speed) around the vertical axis of the center of gravity of vehicle 100. The yaw rate sensor is, for example, a gyro sensor, and outputs yaw rate information including the yaw rate of vehicle 100 to ECU 170.

Navigation device 185 includes a GPS receiver 186 configured to specify a location of vehicle 100 based on electric waves from satellites (not shown). Navigation device 185 performs various types of navigation processes of vehicle 100 using the location information (GPS information) of vehicle 100 specified by GPS receiver 186. Specifically, navigation device 185 searches for a traveling route in the airport based on GPS information of vehicle 100 and intra-airport map data stored in a memory (not shown), and outputs information of the searched traveling route to ECU 170.

Communication module 190 is an in-vehicle DCM (Data Communication Module), and is configured to perform bidirectional data communication with a communication device 210 of management server 200 via communication network 500 (FIG. 1).

Management server 200 includes communication device 210, a storage device 220, and a processor 230. Communication device 210 is configured to perform bidirectional data communication with communication module 190 of vehicle 100 and airport server 400 via communication network 500 (FIG. 1). It is assumed that management server 200 is configured to obtain an image from camera system 450 (not shown) via airport server 400; however, management server 200 may be configured to obtain image data directly from camera system 450 by communication device 210 performing data communication with camera system 450.

Storage device 220 includes a user information database (DB) 221 and a vehicle information database (DB) 222. User information DB 221 stores information of a user who utilizes this carrying system 10. The user can utilize carrying system 10 by making registration in advance, and information of the registered user is stored in user information DB 221. A data configuration of user information DB 221 will be described later.

Vehicle information DB 222 stores information of each vehicle 100. Specifically, vehicle information DB 222 stores: the utilization status of each vehicle 100 (such as currently standby, currently utilized, or currently charged); information of the current location thereof; and the like.

Processor 230 is configured to include a CPU, a memory, an input/output buffer, and the like (each not shown). When processor 230 receives, from airport server 400, boarding procedure progress information including the flight schedule of each user and the boarding procedure progress status (including time at which a procedure is finished), processor 230 stores it in user information DB 221 in association with the registration information of each user.

When there is a user (hereinafter, referred to as “delayed user”) who is delayed for the boarding procedure in view of the flight schedule (departure time), processor 230 obtains an intra-airport image captured by camera system 450, so as to detect the delayed user. When the delayed user is detected, processor 230 instructs a currently unutilized (standby) vehicle 100 to be dispatched to the delayed user and to move, after the delayed user rides thereon, to a location of a procedure which the delayed user has not been through.

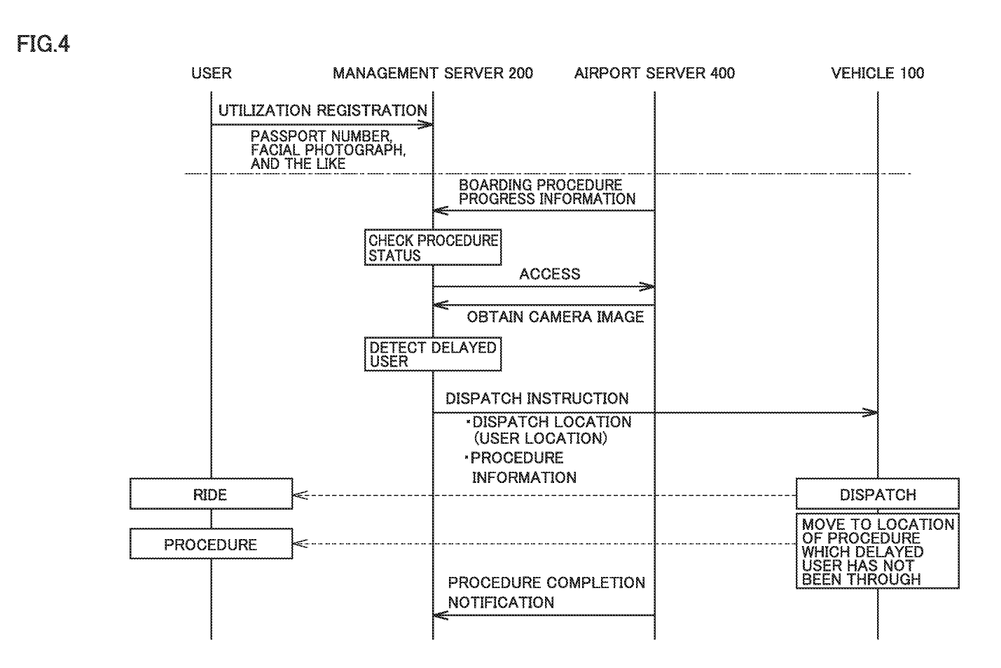

FIG. 4 is a sequence diagram showing exchange of information among respective elements (vehicle 100, management server 200, and airport server 400) of carrying system 10 according to the present embodiment. With reference to FIG. 4, the user needs to make a utilization registration for the system in advance. User information such as the user's passport number and facial photograph is registered in management server 200.

Airport server 400 transmits the boarding procedure progress information of each user, who is scheduled for a flight, to management server 200 on a regular basis or as required by management server 200. The boarding procedure progress information includes: the flight schedule (at least including the departure time) of each user; and the boarding procedure progress status (including time at which a procedure is finished).

When management server 200 receives the boarding procedure progress information of each user from airport server 400, management server 200 checks the procedure status of each user who is scheduled for a flight. Specifically, management server 200 checks whether or not there is a delayed user who has not been through a procedure in the various procedures (the check-in, the safety inspection, the emigration examination (in the case of international flights), and the boarding gate check) even at a closing time, which is determined by the departure time.

When there is a delayed user, management server 200 makes access to airport server 400 (or camera system 450) and obtains an image captured by camera system 450. Then, management server 200 obtains image data of the facial photograph of the delayed user from user information DB 221, and verifies the image captured in the airport by camera system 450 against the image data of the facial photograph of the delayed user, whereby the delayed user is detected. It should be noted that for the verification of the images, known facial recognition techniques can be used.

When the delayed user is detected, management server 200 specifies the location of the delayed user from the captured location in the captured image in which the delayed user is detected, and transmits, to a currently unutilized (standby) vehicle 100 closest to the location of the delayed user, a dispatch instruction for instructing vehicle 100 to be dispatched to the delayed user. This dispatch instruction includes: the dispatch location for vehicle 100 (the location of the delayed user); and the procedure information (boarding procedure progress status) of the delayed user.

When vehicle 100 receives the dispatch instruction from management server 200, vehicle 100 uses navigation device 185 to search for a traveling route from the current location to the dispatch location (the location of the delayed user), and moves (is dispatched) to the delayed user in accordance with the searched traveling route. Then, when vehicle 100 reaches the user and the user rides on vehicle 100, vehicle 100 moves to the location of the procedure which the user has not been through, based on the user's procedure information included in the dispatch instruction sent from management server 200. Then, when the procedure is completed, management server 200 is notified of the completion of the procedure from airport server 400 and the procedure progress status stored in user information DB 221 is updated.

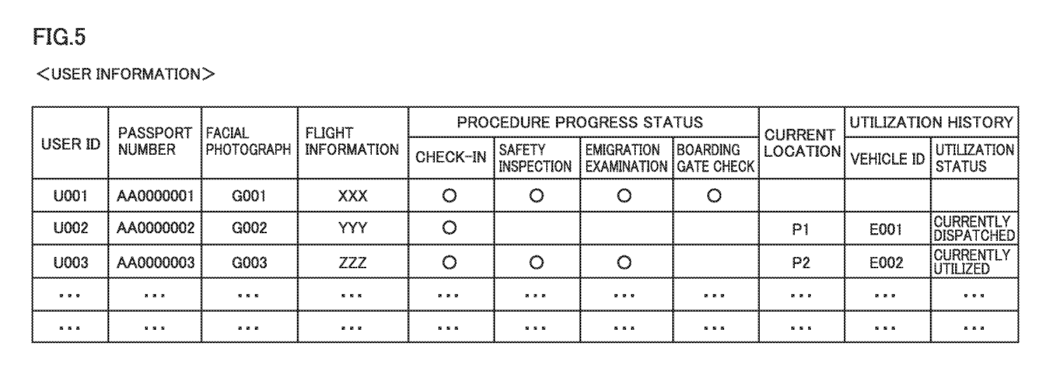

FIG. 5 shows a configuration of the data stored in user information DB 221 of management server 200. With reference to FIG. 5, the user ID is an identification number for specifying the user. The user ID of each user is associated with: the user's passport number and facial photograph registered when making an application for utilization; the flight information of the user; the boarding procedure progress status; the current location of the user; and a utilization history of vehicle 100.

The flight information includes the flight schedule of the outbound flight to be boarded by the user, and at least includes the departure time of the flight. The procedure progress status indicates whether or not the user has been through the various procedures such as the check-in, the safety inspection, the emigration examination (only in the case of international flights), and the boarding gate check. In the case where vehicle 100 is dispatched to the user, before dispatching vehicle 100 to the user, the current location indicates the location of the user specified from the image captured by camera system 450, whereas after dispatching vehicle 100 to the user, the current location indicates the location of vehicle 100. Therefore, after dispatching vehicle 100 to the user, the location information of vehicle 100 is transmitted regularly from vehicle 100 to management server 200. The utilization history includes: data of the vehicle ID and utilization status (currently dispatched, currently utilized, or the like) of vehicle 100 dispatched to the user.

As one example, a user having a user ID of U002 has not been through procedures after the safety inspection, and is therefore determined to be delayed (delayed user) for the procedures in view of the departure time indicated in the flight information. Then, from an image captured by camera system 450, the current location of this user is specified to be P 1. It is indicated that a vehicle 100 having a vehicle ID of E001 is dispatched (is moving) to the user.

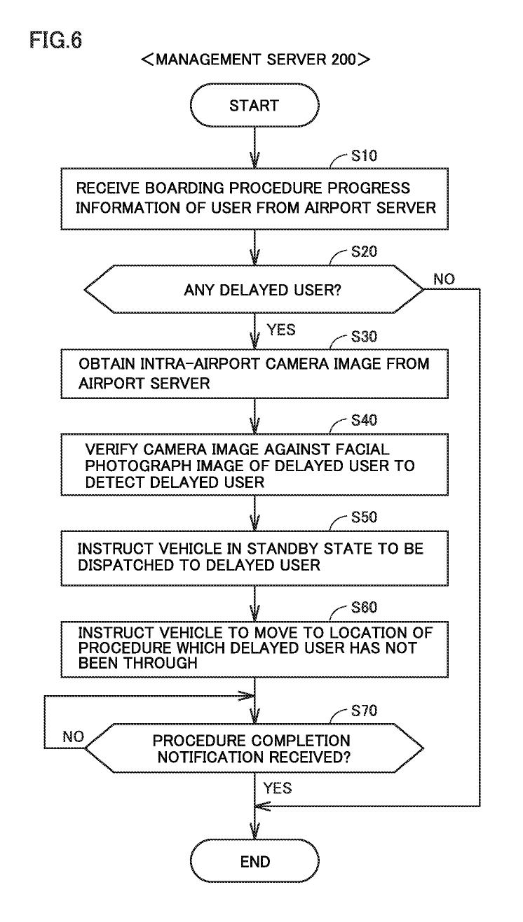

FIG. 6 is a flowchart for illustrating a procedure of processes performed by processor 230 of management server 200. With reference to FIG. 6, management server 200 (processor 230) receives, from airport server 400, the boarding procedure progress information of each user who is scheduled for a flight (step S10). The boarding procedure progress information includes the flight information and the boarding procedure progress status of each user. When management server 200 receives the boarding procedure progress information of each user, management server 200 stores it in user information DB221 in association with the user ID of each user.

Next, for each user, management server 200 calculates the closing time of each of the various procedures (the check-in, the safety inspection, the emigration examination (in the case of international flights), and the boarding gate check) from the departure time included in the flight information, and checks whether or not there is a delayed user who has not been through the procedure even at the closing time (step S20). When there is no delayed user (NO in step S20), management server 200 transfers the process to the end without performing the subsequent series of processes.

When it is confirmed that there is a delayed user in step S20 (YES in step S20), management server 200 obtains, from airport server 400, an image captured by camera system 450 (step S30). It should be noted that management server 200 may obtain the image directly from camera system 450, rather than via airport server 400.

Next, management server 200 reads, from user information DB 221, image data of the facial photograph of the delayed user confirmed in step S20, and verifies the image captured by camera system 450 against the image of the facial photograph of the delayed user, whereby the delayed user is detected (step S40). It should be noted that the detection of the delayed user includes: specifying the delayed user in the image captured by camera system 450; and specifying the location of the delayed user.

When the delayed user is detected, management server 200 transmits, to a (unutilized) vehicle 100 in the standby state, a dispatch instruction for instructing vehicle 100 to move to the delayed user (step S50). It should be noted that in this example, management server 200 transmits the dispatch instruction to a vehicle 100 that is in the standby state and that is closest to the location of the delayed user.

Further, when vehicle 100 is dispatched to the delayed user and the delayed user is confirmed to ride on vehicle 100 (not shown), management server 200 transmits, to vehicle 100, a movement instruction for moving vehicle 100 to the location of a next procedure which the delayed user has not been through (step S60).

Then, when the procedure which the delayed user has not been through is gone through by the delayed user carried by vehicle 100 to the location of the procedure and when management server 200 receives a procedure completion notification from airport server 400 (YES in step S70), management server 200 transfers the process to the end.

As described above, according to the present embodiment, vehicle 100 can be dispatched to the delayed user who is delayed for the boarding procedure at the airport, whereby the user can be immediately transported to the location of the procedure which the user has not been through in the boarding procedure. As a result, flight can be suppressed from being delayed due to the delay of the user for the boarding procedure.

Moreover, in the present embodiment, management server 200 obtains an image captured by camera system 450 installed in the airport, and specifies a location of the delayed user in the airport using the obtained image. Accordingly, even when there is no location information from the user's mobile terminal or the like, the location of the delayed user in the airport can be specified immediately and vehicle 100 can be dispatched to the delayed user.

[Modification]

When the delayed user has a mobile terminal such as a smartphone, management server 200 may transmit a dispatch notification to the user terminal of the delayed user, and then may appropriately modify a dispatch location for vehicle 100 based on the location information (the location information of the delayed user) of the user terminal of the delayed user regularly received from the user terminal. Accordingly, vehicle 100 can be correctly dispatched to the delayed user.

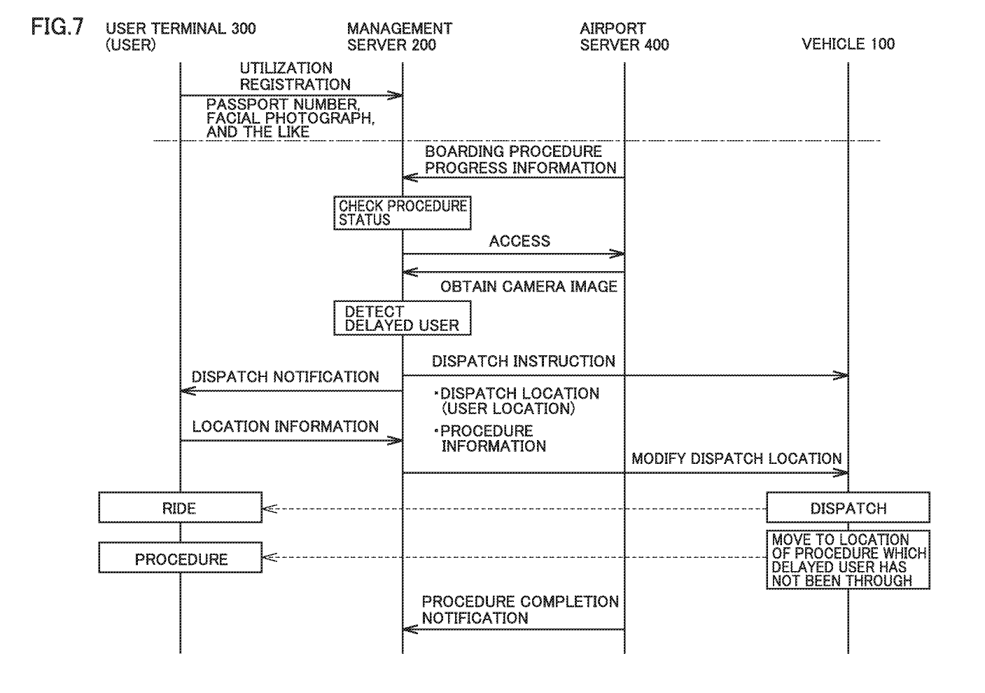

FIG. 7 is a sequence diagram showing exchange of information among respective elements (vehicle 100, management server 200, airport server 400 and user terminal 300) of carrying system 10 according to the modification. With reference to FIG. 7, a series of flow until the dispatch instruction is transmitted from management server 200 to vehicle 100 in response to the detection of the delayed user is the same as the sequence diagram shown in FIG. 4 in the above-mentioned embodiment, and therefore will not be described repeatedly.

Management server 200 transmits the dispatch instruction to vehicle 100, and transmits the dispatch notification to user terminal 300 of the delayed user so as to notify that vehicle 100 is dispatched to the user. When user terminal 300 of the delayed user receives the dispatch notification from management server 200, user terminal 300 then transmits the location information of the terminal (i.e., the location information of the delayed user) to management server 200 regularly.

When management server 200 receives the location information from user terminal 300, management server 200 transmits, to vehicle 100, the dispatch location, appropriately modified by the location information, for vehicle 100. It should be noted that management server 200 may transmit the location information of user terminal 300 received from user terminal 300, to vehicle 100 without modification, and vehicle 100 may appropriately modify the dispatch location based on the received location information of user terminal 300.

It should be noted that a series of flow after the dispatch of vehicle 100 is the same as that shown in the sequence diagram of FIG. 4 in the foregoing embodiment and therefore will not be repeatedly described.

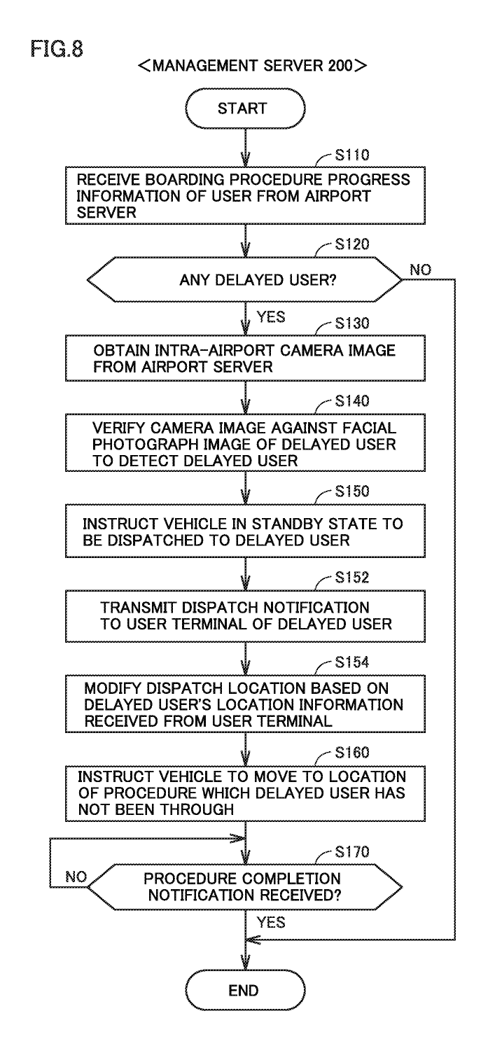

FIG. 8 is a flowchart for illustrating a procedure of processes performed by processor 230 of management server 200 in the modification. With reference to FIG. 8, the processes performed in step S110 to step S150 are respectively the same as the processes performed in step S10 to step S50 shown in FIG. 6 and therefore will not be repeatedly described.

When the dispatch instruction for instructing to move to the delayed user is transmitted to (unutilized) vehicle 100 that is in the standby state in step S150, management server 200 (processor 230) transmits the dispatch notification to user terminal 300 of the delayed user to notify that vehicle 100 is dispatched to the delayed user (step S152).

When the dispatch notification is transmitted from management server 200 to user terminal 300 of the delayed user, the location information of user terminal 300 (the location information of the delayed user) is then transmitted regularly from user terminal 300 to management server 200.

Then, based on the location information of the delayed user received from user terminal 300, management server 200 appropriately modifies the dispatch location for vehicle 100 to the user, and transmits it to vehicle 100 (step S154). Then, management server 200 transfers the process to step S160.

It should be noted that the processes performed in step S160 and step S170 are respectively the same as the processes performed in step S60 and step S70 shown in FIG. 6 and therefore will not be repeatedly described.

As described above, according to this modification, since management server 200 obtains the location information of the delayed user from user terminal 300 of the delayed user and modifies the dispatch location for vehicle 100 in accordance with the obtained location information, vehicle 100 can be correctly dispatched to the delayed user.

It should be noted that in the embodiment and modification above, the delayed user is detected using the image captured by camera system 450; however, the delayed user may be detected using the location information of user terminal 300 when utilization of user terminal 300 in the airport is registered in advance.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A carrying system for carrying a user to a location of a procedure required for boarding in an airport, the carrying system comprising:
a movable body configured to perform unmanned driving and used for transportation of the user in the airport; and
a management server configured to manage movement of the movable body,
the management server being configured to
receive a flight schedule and a boarding procedure progress status of the user from an airport server configured to manage a boarding procedure of the user,
specify a location of a delayed user in the airport, the delayed user being the user who is delayed for the boarding procedure, and
dispatch the movable body to the delayed user and transmit, to the movable body, an instruction for carrying the delayed user to a location of a procedure which the delayed user has not been through in the boarding procedure,
the movable body being configured to
move to the delayed user in accordance with the instruction, and
move, in accordance with the instruction, to the location of the procedure which the delayed user has not been through, after the delayed user rides on the movable body.

2. The carrying system according to claim 1, wherein
the management server is configured to
obtain images of a plurality of cameras installed in the airport, and
specify a location of the delayed user in the airport using the obtained images.

3. The carrying system according to claim 1, wherein
the management server is configured to
obtain location information of the delayed user from a mobile terminal of the delayed user, and
modify a dispatch location for the movable body in accordance with the obtained location information.

4. A management server comprising:
a communication device configured to communicate with a movable body, the movable body being configured to perform unmanned driving and used for transportation of a user in an airport; and
a processor configured to perform first to third processes,
the first process being a process for receiving a flight schedule and a boarding procedure progress status of the user from an airport server configured to manage a boarding procedure of the user,
the second process being a process for specifying a location of a delayed user in the airport, the delayed user being the user who is delayed for the boarding procedure,
the third process being a process for dispatching the movable body to the delayed user and transmitting, to the movable body, an instruction for carrying the delayed user to a location of a procedure which the delayed user has not been through in the boarding procedure.

5. A method for carrying a user in an airport using a movable body configured to perform unmanned driving, the method comprising:
obtaining a flight schedule and a boarding procedure progress status of the user from an airport server configured to manage a boarding procedure of the user;
specifying a location of a delayed user in the airport, the delayed user being the user who is delayed for the boarding procedure;
dispatching the movable body to the delayed user and notifying, to the movable body, an instruction for carrying the delayed user to a location of a procedure which the delayed user has not been through in the boarding procedure;
moving the movable body to the delayed user in accordance with the instruction; and
moving, in accordance with the instruction, the movable body to the location of the procedure which the delayed user has not been through, after the delayed user rides on the movable body.
